(19) United States
(12) Patent Application Publication
(10) Pub. No.: US 2011/0018252 A1
(43) Pub. Date: Jan. 27, 2011

(54) SECURITY PIGMENT

(75) Inventors: Ralf Petry, Griesheim (DE); Michael Weiden, Darmstadt (DE); Sylke Klein, Rossdorf (DE); Klaus-Christian Ullmann, Bensheim (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MIT PATENT GESELLSCHAFT

(21) Appl. No.: 12/745,977

(22) PCT Filed: Nov. 12, 2008
(86) PCT No.: PCT/EP08/09533

§ 371 Date: Sep. 20, 2010

(30) Foreign Application Priority Data
Dec. 4, 2007 (DE) 10 2007 058 601.0

(51) Int. Cl. B42D 15/10; C04B 14/00; C04B 14/04; C04B 14/30; C04B 14/36; C09D 5/00

(52) U.S. Cl. 283/72; 106/400; 106/482; 106/401; 106/461; 106/436; 106/425; 106/456; 106/453; 106/480; 106/31.01

(57) ABSTRACT

The present invention relates to a security pigment having an intrinsic hidden and/or forensic security feature, consisting of a transparent inorganic matrix and at least one particulate material embedded in the matrix, to the use of a security pigment of this type for the pigmentation of paints, coatings and the like, and to a method for the detection of a security pigment of this type.

The present invention relates to a security pigment having an intrinsic hidden and/or forensic security feature, which can be used for the pigmentation of paints, coatings, powder coatings, printing inks, coating compositions, plastics, adhesives, papermaking stocks, building materials, rubber compositions, explosives or the like and preferably serves therein for the identification or verification of the authenticity of these products. The security pigment according to the invention accordingly also has particular advantages in the pigmentation of security documents and security products.

The protection of products of all types against imitation and counterfeiting is increasing in importance. In particular, high-value proprietary products are often imitated and offered for sale in remarkably convincing packaging. It is frequently also the case that pharmaceuticals or replacement parts of vehicles are subject to the attacks by counterfeiters, resulting not only in material losses for the manufacturers of the original products, but also possibly giving rise to fears of considerable health damage or risks to the consumers.

Major efforts are therefore being made by industry to protect the manufacturers of proprietary products of all types against image loss and claims for damages and customers or patients against unforeseeable effects of products. It is undoubtedly the case here that products which, owing to the nature of their use, are anyway subject to particular security precautions, namely security documents or security products, such as banknotes, cheques, bank and credit cards, cheque cards, securities, certificates, identity cards and the like, must be provided with evidence of their authenticity in a particularly multifarious and counterfeiting-proof manner.

The security features in the above-mentioned products are integrated into the product if its nature permits or are applied directly to the product or its packaging.

In general, a distinction is made in security features between open and hidden security features. In general, a combination of the two is used.

Open security features are intended to be readily accessible to the untrained viewer in order that he can easily check the authenticity of the product himself with reference to certain visible, known signs. Open security features are therefore those which can be detected without aids or using only simple aids. To this end, use is frequently made of coloured security elements, in particular those with a colour flop effect, which change their colour depending on the illumination and/or viewing angle, holograms, kinegrams, watermarks, security threads or the like. Security elements of this type serve for basic identification by the end customer, customs or informed experts and are easy to identify (identification level 1).

For the qualified identification of security elements, use is made of hidden security features (level 2), which are invisible without aids and are only brought to the attention of qualified viewers, such as, for example, certified dealers or inspectors, customs or other authorities. Security elements of this type can only be detected after training and consist, for example, of additives which develop UV or IR activity at certain points of the products under certain conditions or of liquid-crystalline materials or taggants employed specifically, of which the latter, for example, can be identified via a certain sequence of their layer structure, are only present in extremely low concentration and are only visible using certain aids (magnifying equipment).

The highest identification level (level 3) is attained by forensic features which serve for product monitoring by the trademark owner and are not brought to the attention of anyone apart from the trademark owner, legal authorities and specialists. Security features of this type can only be detected with certain technical and informative prerequisites and are intended to serve, in particular, for proving product authenticity or counterfeiting in court, for product monitoring via distribution chains, for the discovery of black sheep in the production or distribution chain, for uncovering product misappropriation, parallel trading and illegal re-imports or the like. Examples thereof are DNA taggants, smart label RFID transponders or the like.

Taggants are particles on a micro scale which are usually added to a product in very small amounts in order to be detectable again under certain conditions and thus to serve for product identification or demonstration of the authenticity of the products. They have specific particle properties which simplify their detection or assignment. They are frequently multilayered particles, which can be coded via the colour and/or the sequence of the layers and can thus be traced to certain products, product batches or manufacturers.

The chemical or physical properties of such particles can also form the basis for their ability to be detected again.

Taggants are generally added to the respective products only in such amounts that they can just about be identified under prespecified conditions, but are invisible without corresponding aids. The latter requires that their properties are designed in such a way that they do not influence the appearance of the product as a whole to such an extent that it can already be distinguished visually from comparable products without addition of these taggants.

The use of effect pigments as taggants has already been described. Thus, for example, WO 2005/055236 describes a process for checking the authenticity of polymers to which taggants have been added, in which the taggants employed are, for example, flake-form metal pigments which have a printed microscopically small code on their surface or special particles which exhibit a colour change depending on the viewing angle.

In polymers which may otherwise have been coloured using organic soluble dyes, particles of this type can be detected relatively well by trained viewers. However, in the case where the polymers have been mass-coloured anyway using effect pigments which have a similar material composition to the taggants and, since they are used for colouring, are employed in relatively large amounts, the detection of the taggants and thus the checking of the authenticity of the product is thus only possible with great difficulty, even for the trained expert.

U.S. Pat. No. 4,243,734 discloses the use of polymer flakes or of flakes of the same shape and size which have been stamped or cut out of metal foils and which carry symbols on their surface which can be traced to the manufacturer or owner, as taggants. However, the preparation of taggants of this type is very expensive since a large number of tools is necessary to be able to apply the various symbols individually of the particles. The number of possible variations is thus very limited and the cost of the products to be identified is greatly increased. Fast adaptation to desired changes in the outer shape and the material of the taggants is also associated with additional cost.

U.S. Pat. No. 6,643,001 also describes flakes having a certain shape and size which can be coded via a pattern applied to their surface and can be employed for the identification of products. The flakes may additionally also be coated with fluorescent layers. They substantially consist of liquid-crystalline cholesteric materials, which provide them with an appearance which changes in colour with the viewing angle (tilt effect or colour flop). However, liquid-crystalline materials of this type can only be converted into the desired uniform particle shapes with great difficulty since polymerised layers of the liquid-crystalline material have to be divided in a suitable manner. Coding on the surface of the flakes is also only possible with a special treatment which does not destroy the optical properties of the polymeric liquid-crystalline materials.

EP 978 373 discloses pigments which are obtained by comminution of inorganic layer packages which have at least two layers having different chemical and/or physical properties lying one above the other. These pigments have one or more symbols on their surface and can be employed as taggants. These pigments are said to preferably have a colour flop on viewing from different angles and significantly more than two layers. The symbols are said to be applied to the surface of the pigments via a laser.

The layer structure of such pigments is very complex and the application of microscopically small symbols by laser is very difficult since the laser must produce a very fine line structure in order that each pigment has at least one identifiable part of the symbol. In addition, a colour flop at pigments scattered in a product is only perceptible as a different colour of the individual particles, depending on how the pigments are aligned in the product. On tilting the product to a different viewing angle, by contrast, no colour flop is visible for the individual particles. Identification of the particles is in practice therefore only possible via the symbols or symbol parts located on the surface.

WO 2005/017048 describes flakes for hidden security applications which consist of a single inorganic dielectric layer and have a selected shape and/or have a pattern or symbol on their surface. These flakes preferably consist of zinc sulfide. If this material is treated appropriately, it can also fluoresce. In media which are additionally pigmented otherwise, however, the outer shape of the flakes can only be distinguished with great difficulty from the outer shape of the other pigments present in much larger amount, meaning that again only the symbols on the surface of the flakes or, where appropriate, the fluorescent behaviour of the flakes can serve as essential distinction criterion.

The taggants described above in the prior-art documents essentially use, as common criteria for their identification, either the outer shape of the particles and/or the patterns located on the surface. If the particles additionally have luminescent properties, these in each case relate to the entire particle surface through the use of the materials. In these cases, the identification feature used in the presence or non-presence of luminescence. Distinction features of this type are hidden features which belong to identification level 2. Taggants from identification level 3, which, besides hidden features, also contain forensic features, have not been described in the cited documents.

The object of the invention now consists in providing security pigments which can be employed for the pigmentation and simultaneous identification/authenticity checking of products of a wide variety of types and contain hidden and/or forensic security features, where the security features in the security pigments can optionally be combined with one another without major technological complexity, the security pigments allow specific product coding and can be detected in various graduations at different identification levels.

A further object of the invention consists in indicating a use of the security pigment according to the invention.

An additional object of the present invention consists in providing a method for the detection of the security pigment according to the invention in a medium or product pigmented therewith.

The object of the present invention is achieved by a security pigment having an intrinsic hidden and/or forensic security feature, consisting of a transparent inorganic matrix and at least one particulate material embedded in the matrix which is different from the matrix and selectively or non-selectively absorbs, reflects and/or emits visible light on exposure to electromagnetic radiation.

The object of the invention is furthermore achieved by the use of the said security pigment for the pigmentation of paints, coatings, powder coatings, printing inks, coating compositions, plastics, adhesives, papermaking stocks, building materials, rubber compositions and explosives.

In addition, the object of the invention is achieved by a method for the detection of the security pigment according to the invention, in which a medium comprising the security pigment or a product comprising a medium of this type is exposed to electromagnetic radiation and viewed at a magnification which is sufficiently large to enable, in a first step, the outer shape and size of the security pigment to be recognised and, in a second step, to enable the shape, size, number and/or colour of the particulate material embedded in the matrix to be recognised.

The security pigment according to the invention consists of a transparent inorganic matrix and at least one particulate material embedded in the matrix which is different from the matrix and selectively or non-selectively absorbs, reflects and/or emits visible light on exposure to electromagnetic radiation.

For the purposes of the present invention, an inorganic matrix is intended to be regarded as transparent if it essentially, i.e. to the extent of at least 90%, transmits visible light. Matrix here denotes a substance composition in which other constituents are embedded. The material employed for the transparent inorganic matrix can in principle be all inorganic materials whose precursor is capable of taking up particulate materials during the preparation process of the security pigment and which, in the solid state, are transparent to visible light and are substantially chemically and physically stable.

The transparent matrix here may be coloured or colourless. It is preferably colourless.

The transparent inorganic matrix preferably consists of silicon dioxide, silicon oxide hydrate, aluminium oxide, aluminium oxide hydrate, magnesium oxide or a mixture of two or more of these compounds (matrix having a low refractive index) or of titanium dioxide and/or titanium dioxide hydrate (matrix having a high refractive index).

The inorganic matrix may also consist of a mixture of titanium dioxide and/or titanium dioxide hydrate with one or more of the other materials mentioned in the preceding section. In such cases, the assignment of whether it is a matrix having a high refractive index or having a low refractive index is dependent on the percentage proportion of the respective materials. However, a mixture of this type does not represent a particularly preferred embodiment of the present invention.

Suitable particulate materials which are embedded in the matrix are all particulate materials which selectively or non-selectively absorb, reflect and/or emit under the influence of electromagnetic radiation of at least one wavelength or a wavelength range.

This means that the particulate material has at least one visible colour under the influence of the radiation of at least one part-region of the electromagnetic (solar) spectrum.

This can be, for example on incidence of the visible wavelength region of sunlight (λ=380-780 nm) on the particulate material, a visible reflected colour which emanates from selective absorption by the particulate material, for example a red, blue or green reflection colour with correspondingly complementary absorption. By contrast, particulate material which non-selectively absorbs visible radiation generally has a visible, essentially white or black colour.

Suitable as further particulate material are also materials which have a visible colour under the influence of electromagnetic radiation outside the visible wavelength region of light, i.e. materials which are excited to emit visible light under these conditions, for example on incidence of infrared (IR) (λ>780 nm) and/or ultraviolet (UV) light (λ<380). Such materials are also known as IR upconverters or UV downconverters. They luminesce under the said conditions in the visible wavelength region.

This visible light may again either be white (excitation to emit over a broad wavelength spectrum) or coloured (excitation to emit over a relatively tightly restricted wavelength range).

The security pigment according to the invention has essentially a flake shape. This means that it is a flat structure which has two surfaces approximately parallel to one another on its top and bottom sides, whose length and width dimension represents the greatest dimension of the pigment. The separation between the said surfaces, which represents the thickness of the flake, has, by contrast, a smaller dimension.

The length and width dimension of the security pigment according to the invention is between 1 μm and 250 μm, preferably between 2 μm and 100 μm, and particularly preferably between 5 μm and 60 μm. The thickness is from 0.1 μm to 12 μm, preferably from 0.1 to less than 10 μm, particularly preferably from 0.1 μm to 5 μm and especially preferably from 0.2-2 μm.

The aspect ratio of the flakes, i.e. the ratio of the greatest length or width dimension to the thickness, here is at least 2:1, but preferably 10:1 and very particularly preferably greater than 20:1.

When the largest surface of the flake-form pigment is viewed from above, this can be both a regular and an irregular shape.

For the purposes of the invention, regular means that the flake-form pigment can have a predetermined shape, which may be, for example, the shape of a regular or irregular polygon, a circle or an ellipse.

However, it is preferred for the shape of the largest surface of the pigments according to the invention to be irregular in plan view. In this case, the outer shape is not defined and can be both pointed and angular and also round or have rounded-off edges or have both in combination with one another. The outer shape of the security pigment according to the invention thus cannot be distinguished from the outer shape of other effect pigments regularly used for the pigmentation of surface coatings, printing inks, polymer compositions and the like. The latter generally likewise have irregular shapes.

In the security pigment in accordance with the present invention, the matrix has a refractive index n₁ and the particulate material has a refractive index n₂, where n₁ is different from n₂ and the difference Δn between n₁ and n₂ is at least 0.2.

If the matrix has a low refractive index, it has a refractive index n₁<1.8 and consists of silicon dioxide, silicon oxide hydrate, aluminium oxide, aluminium oxide hydrate, magnesium oxide or a mixture of two or more of these compounds.

In order to obtain a high-refractive-index matrix which has a refractive index n₁≧1.8, titanium dioxide and/or titanium dioxide hydrate are preferably employed as matrix material.

The thickness of the solidified matrix is from 0.05 μm to less than 10 μm, preferably from 0.1 μm to 5 μm and particularly preferably from 0.2-2 μm.

In a particularly preferred embodiment of the present invention, the matrix consists of silicon oxide and/or silicon dioxide hydrate.

The particulate material embedded in the matrix is a substantially spherical or three-dimensionally regularly or irregularly shaped material and has a particle size of 0.01 to 12 μm.

It is noteworthy here that the particle size of the particulate material does not necessarily have to be less than the thickness of the solidified matrix in which the particulate material is embedded. In contrast to interference pigments, in which the formation of particularly smooth surfaces is important in order to achieve the desired interference effect to a large extent, it is entirely possible for a certain roughness of the pigment surface, which is caused by embedded particles projecting over the matrix surface, to occur in the security pigments according to the invention. The occurrence of interference effects at the surface of the security pigments according to the invention is, by contrast, rather undesired, even in the case of a multilayered structure of the pigments, and is therefore also not preferred.

The particulate material employed is at least one inorganic white, black or coloured pigment, an inorganic UV pigment, an inorganic IR upconverter pigment, an encapsulated organic dye, an encapsulated UV or IR upconverter material or mixtures of two or more thereof.

White, black or coloured pigments which can be employed here are in principle all colouring pigments which can be ground finely to the desired particle size and retain their shape and size on introduction into the matrix. The pigments which have high tinting strength, even in the finely divided state as individual particles, are preferred here. These are, for example, titanium dioxide, barium sulfate, zinc oxide, pigment black, iron oxides (haematite, magnetite), chromium oxide, Thénard's Blue (CoAl₂O₄), Rinman's Green (ZnCO₂O₄), cobalt-chromium-aluminate spinel ((Co, Cr)Al₂O₄) or mixtures of two or more thereof.

Suitable as particulate material for embedding in the matrix are likewise materials which emit visible light on excitation by UV radiation. These can be, for example, a doped metal oxide, a doped metal sulfide, a metal oxysulfide of the lanthanides or a mixed oxide which is capable of fluorescence or a mixture of two or more thereof.

Materials of this type are known and are generally referred to as UV-fluorescent pigments. Typical representatives are, for example, Zns:Cu, Gd oxysulfide, Y oxysulfide or mixed oxides, such as, for example, Ba/Mg aluminates, to mention but a few.

The use of materials of this type in security products in general is widespread. A large number of usable substances are therefore available to the person skilled in the art. These are usable, unrestricted by their material composition, so long as they can be brought into the required particle size.

Particulate materials which emit visible light on excitation by IR radiation, i.e. the so-called IR upconverters, are likewise suitable for use in the security pigment according to the invention. These are, for example, an oxide, halide, chalcogenide, oxyhalide, oxysulfide, fluoroarsenate or fluoroindate of the elements Li, Na, K, Mg, Ge, Ga, Al, Pb, Cd, Ba, Mn, Nb, Ta, Cs, Y, Nd, Gd, Lu, Rb, Sc, Bi, Zr and W which is doped with at least one transition-metal ion, lanthanide ion and/or actinide ion, or a mixture of two or more thereof.

Particularly suitable doping ions here are the transition-metal ions, lanthanide ions and/or activide ions Ti²⁺, Cr³⁺, Ni²⁺, Mo³⁺, Re⁴⁺, Os⁴⁺, Pr³⁺, Nd³⁺, Gd³⁺, Dy³⁺, Ho³⁺, Er³⁺, Tm²⁺, U⁴⁺ and/or U³⁺.

IR upconverters which are very frequently employed are mixtures of oxyhalides or oxysulfides or multidoped compounds.

These are, for example, mixtures which comprise yttrium oxysulfide and one or more compounds selected from gadolinium oxysulfide, ytterbium oxysulfide, erbium sulfide and thulium oxysulfide. Mixtures of gadolinium oxychloride/fluoride with ytterbium oxychloride/fluoride and/or erbium oxychloride/fluoride or compounds such as Y₂O₃:Yb,Er, Nd:YAG and Li,NaYF₄:Er are also commercially available as IR upconverters. They are readily available on the market and are therefore preferred for use in the security pigment according to the invention. In principle, all commercially available IR upconverter materials can be employed so long as they retain shape and size on incorporation into the matrix and in the subsequent solidification process and are mechanically and chemically stable.

The said UV materials and IR upconverter materials may also be in encapsulated form. The capsule (protective sheath) here may consist of an inorganic material or of organic polymers and is generally used to protect the material lying in the core or to convert a liquid luminescent substance into a solid form which can be handled. Encapsulated materials of this type which luminesce in the visible wavelength region on UV or IR excitation are also commercially available in the said particle sizes. Known UV-fluorescent dyes which are actually dissolved are, for example, coumarines, rhodamines, phthaleins, such as fluorescine, uranine, or stilbene or pyrazole derivatives, such as Blankophor, inter alia.

Dissolved and soluble organic dyes can likewise be employed in encapsulated form. The capsule prevents complete colouring of the matrix material if the organic dye is introduced into the matrix. Suitable organic dyes are all own dyes which can be encapsulated in a suitable manner. An example which should be mentioned here is a hydroxyanthraquinone dye which is soluble in caustic lye or an acidic azo dye.

The above-mentioned particulate materials are present either individually or in the form of a mixture in the security pigment according to the invention. The mixtures here may consist of a plurality of the same type, for example a plurality of black, white or coloured pigments, a plurality of UV pigments or IR upconverter pigments, which are mixed amongst one another or with one another, or of black, white or coloured pigments which are mixed with one or more different luminescent particulate materials.

Particular preference is given to an embodiment of the present invention in which the particulate material is a mixture of at least one selectively or non-selectively absorbent material and at least one emitting material.

Particularly preferred embodiments of the present invention have particulate particles comprising titanium dioxide, titanium dioxide and iron oxide (haematite), UV pigment (for example ZnS:Cu), UV pigment and titanium dioxide and/or iron oxide, IR upconverter (for example mixture of yttrium oxysulfide with gadolinium oxysulfide, ytterbium oxysulfide and erbium oxysulfide), IR upconverter and UV pigment, IR upconverter and titanium dioxide and/or iron oxide, embedded in a matrix comprising silicon dioxide.

When the pigment according to the invention is viewed under a light microscope, the particulate material appears white (TiO₂), red-brown/orange (Fe₂O₃) and bright white or coloured on excitation by UV and/or IR radiation.

The particulate material is present in the matrix in a proportion of 1 to 860% by weight, based on the total weight of the security pigment. The proportion of the particulate material in the matrix is preferably 1 to 60% by weight and particularly preferably 10 to 50% by weight, based on the total weight of the security pigment.

As already mentioned above, the particulate materials embedded in the security pigment according to the invention are perceptible as individual particles at appropriate magnification under a light microscope, where appropriate after excitation with UV and/or IR radiation, or under a UV microscope. The (precise or approximate) number of particles here and their colour, size or proportion in the matrix can be determined visually in a simple manner. The change in these parameters can therefore be used specifically to code the security pigment according to the invention by manufacturer, batch, production period, distribution route, etc. The untrained viewer, even if he is capable of locating the security pigment according to the invention in the application medium and recognising the embedded particulate materials, for example through their colour, but is not informed coding, is also unable to decode the code intrinsically inherent to the security pigment.

The particle size of the particulate material in conjunction with the fraction of the particles that can be observed under visible light and/or the colour of the particulate material that can be observed on exposure to visible, UV, and/or IR light therefore represents a forensic code which only discloses itself to a few informed and trained viewers of the security pigment.

In a further embodiment of the present invention, the security pigment additionally has a single- or multilayered coating which surrounds it completely. The additional coating preferably consists of at least one inorganic dielectric material.

Suitable inorganic dielectric materials are in principle all known inorganic dielectric materials, such as metal oxides, metal oxide hydrates or mixtures thereof, metal mixed oxides, suboxides, oxynitrides or metal fluorides.

In particular, coloured or colourless metal oxides selected from TiO₂, Fe₂O₃, Fe₃O₄, SnO₂, Sb₂O₃, SiO₂, Al₂O₃, ZrO₂, B₂O₃, Cr₂O₃, ZnO, CuO, NiO or mixtures thereof, or magnesium fluoride can be employed.

Particularly suitable are colourless metal oxides, such as TiO₂, SnO₂, SiO₂, Al₂O₃, ZrO₂, B₂O₃ and ZnO, and oxide hydrates thereof.

The material for the coating may correspond to the material of the matrix or be different therefrom.

Coatings which consist of a plurality of layers are also possible. The layer of a multilayered coating of this type facing the matrix may likewise correspond to the material of the matrix or be different therefrom.

The additional coating serves for modification of the surface of the security pigment. This may be both a layer sequence generally known as post-coating, which is composed of one or more inorganic and/or organic layers having layer thicknesses in the single-digit nanometre region and serves for improving the surface properties of the security pigments according to the invention with respect to incorporation thereof into application media, such as, for example, printing inks. A post-coating of this type is usually applied in the case of various pigments, for example interference pigments, and does not impair their optical behaviour. It is familiar to the person skilled in the art.

However, a modification of the surface of the security pigment according to the invention may also be carried out in such a way that the refractive index of the matrix is to be modified compared with the application medium through the additional coating.

In this case, the additional coating consists of at least one inorganic dielectric material and, in an embodiment of the invention, has, at least on its surface facing away from the matrix, a refractive index n₃ which is different from the refractive index n₁ of the matrix.

In a further embodiment of the invention, the coating consists of at least one inorganic dielectric material and has, at least on its surface facing away from the matrix, a refractive index n₃ which is different from the refractive index n₂ of the particulate material.

In an additional embodiment of the invention, the coating consists of at least one inorganic dielectric material and has, at least on its surface facing away from the matrix, a refractive index n₃ which is substantially equal to the refractive index n₂ of the particulate material.

In addition, in a further embodiment of the invention, the coating consists of at least one inorganic dielectric material and has, at least on its surface facing away from the matrix, a refractive index n₃ which is different from the refractive index n₄ of a medium surrounding the security pigment.

The embodiments given above will be explained below with reference to simple examples.

Firstly, however, the optical behaviour of a security pigment according to the invention which has either no additional coating or only one so-called post-coating will be explained. In a security pigment of this type, the optical properties in the application medium are determined by material of the matrix and the material of the embedded particulate material.

The application media which are usual for pigments, such as coating compositions, paints, lacquers, printing inks or plastic compositions, generally have relatively low refractive indices in the range from about 1.5 to about 1.65. Whether pigments which are introduced into an application medium of this type are visible therein depends on the refractive index difference of the two materials besides on the colours of the application medium and pigment. If application medium and pigment both colourless and transparent, the visibility of the pigment depends only on the refractive index difference of the two materials.

A pigment having a matrix comprising SiO₂, which generally has a refractive index of about 1.45 to 1.5 is thus invisible as such with its outer shape in an application medium which has a refractive index of 1.5 to 1.65.

If, by contrast, a pigment of this type comprises a finely divided particulate material, as in the present invention, these particles can be detected at a correspondingly high magnification in a light microscope if they have a refractive index difference to the matrix. In transmitted light, particles of this type can also be rendered visible by the scatter effects generated. This visibility is independent of any coloration of the particulate material or its UV/IR activity.

If the concentration of the particulate material is sufficiently high and its particle size sufficiently small, the shape of the security pigment can also be concluded from the shape of the accumulation of the particulate material in the application medium, although its outer contours are not directly visible.

If, by contrast, the matrix consists of a high-refractive-index material, such as TiO₂ or titanium oxide hydrate, which have a refractive index of about 2.4, the security pigment according to the invention will be visible in its contour in the application medium, since the refractive index difference is sufficient here.

If a security pigment which has a matrix comprising SiO₂ (n₁=1.45) is now provided with a coating comprising TiO₂ (n₃=2.4), the contours of a pigment of this type in an application medium which has the refractive index n₄=1.5 can be detected in a light microscope.

The embedded particles, which are either coloured and/or IR/UV-active, can then be rendered visible if the magnification of the light microscope is subsequently increased and/or an IR/UV light source is used.

If a difference exists in the refractive index of the particulate material n₂ and the refractive index n₃ of the coating, even an IR/UV material which is otherwise colourless may be visible in a light microscope at a correspondingly high magnification.

If, by contrast, the refractive index n₂ of a particulate IR/UV material is substantially equal to the refractive index of the additional coating, in each case only the outer shape of the security pigment according to the invention is detectable in the application medium in a light microscope. The IR/UV-active embedded particles are, by contrast, only visible on corresponding excitation and are then, depending on the concentration in the security pigment, in the form of an accumulation in an extremely small space, which cannot be achieved in conventional security products, which comprise, for example, particulate materials of this type in a random distribution in the application medium. This is a major advantage of the present invention, which can provide clear evidence of, for example, IR- and UV-active luminescent materials with a small amount of luminescent substances in the end product and nevertheless still allows coding.

It goes without saying that the material for the additional coating is matched, depending on the circumstances, to the material of the matrix and the particulate material with respect to the refractive index in such a way that the desired effects arise.

A suitable high-refractive-index material for a matrix comprising SiO₂ is, for example, SnO₂, TiO₂ or Al₂O₃, optionally also as a mixture or in successive layers. By contrast, a matrix comprising TiO₂ can be modified in its refractive index, for example, by a coating comprising SiO₂, SnO₂ or Al₂O₃ in such a way the that refractive index of the coating is lower than the refractive index of the matrix.

The security pigments according to the invention are prepared by applying a mixture of one or more of the particulate materials described above with a liquid or flowable precursor, which is necessary for the formation of the matrix, to a sheet-like support in such a way that a homogeneous film forms, this film is solidified by drying, detached from the support and comminuted, giving pigments comprising a solid matrix with embedded particulate material.

If necessary, these pigments can be subjected to further drying and comminution steps and/or calcination steps.

Processes of this type are known per se and are generally carried out in a belt apparatus. For the formation of a solid matrix, it may be necessary here to treat the solidified precursor film with water, acid and/or caustic lye in order to obtain a stable matrix. The sequence in which the particulate materials are added to the precursor is generally unimportant. Likewise, the mixing of precursor and particulate materials may only be carried out directly on the sheet-like support.

Suitable starting materials (precursor) for the preparation of the security pigment according to the invention are, in particular, sodium water-glass and potassium water-glass, hydrolysable titanium compounds, such as titanium tetrachloride, and hydrolysable aluminium and magnesium compounds. Corresponding processes are described in EP 608 388 and in DE 19 618 564.

If the security pigments according to the invention are provided with a further coating, this coating can be carried out in accordance with the processes for the coating of interference pigments, which are adequately known. Wet-chemical coating processes with organic or inorganic hydrolysable metal compounds are preferably preferred as starting materials here since they result in uniform coating of the pigments at acceptable cost. Particular preference is given to processes in which exclusively inorganic starting materials are employed.

In contrast to the coating of interference pigments with dielectric layers, a perfectly smooth surface of the pigments, uniform layer thickness of the surrounding layers or the compliance with certain, tightly restricted layer thicknesses of the coating are not important in the case of the security pigments according to the invention. Instead, it is sufficient for the security pigment according to the invention to be completely surrounded by a coating which preferably has, on its surface facing the application medium, a refractive index which is different from the refractive index of the matrix.

Wet-chemical coating processes of flake-form pigments are known, for example, from the documents DE 14 67 468, DE 19 59 998, DE 20 09 566, DE 22 14 545, DE 22 15 191, DE 22 44 298, DE 23 13 331, DE 25 22 572, DE 31 37 808, DE 31 37 809, DE 31 51 355, DE 32 11 602 and DE 32 35 017.

If a titanium dioxide having a particularly high refractive index (rutile) is to be applied, it is advisable to apply a thin tin-oxide layer in advance.

After application of the further coating, it is advantageous for the pigments obtained to be calcined at temperatures between 100° C. and 1000° C., preferably at temperatures between 100° C. and 300° C., for pigments which comprise IR/UV-active particulate materials.

The security pigment according to the invention is employed in accordance with the present invention for the pigmentation of paints, coatings, powder coatings, printing inks, coating compositions, plastics, adhesives, papermaking stocks, building materials, rubber compositions, explosives, etc.

It is particularly preferred here for the security pigment to be employed as taggant.

As described above, taggants are present in very low concentrations in the materials pigmented therewith, so that it is just possible for them to be detected and analysed.

In general, the conventional application media are anyway pigmented with various pigments for colouring.

It is important for the present invention that the security pigment, if it is employed in a mixture with coloured and/or effect pigments, does not significantly impair, modify or determine the colour impression generated by the latter.

In accordance with the invention, the security pigment is therefore added to the paint, coating, powder coating, printing ink, coating composition, plastic, adhesive, papermaking stock, building materials, rubber compositions or explosives in an amount of 0.0001 to 20% by weight, based on the total weight of the respective material. The proportion of the security pigment here is of course dependent on the type of application medium. Whereas extremely small amounts are sufficient in the case of building materials, such as, for example, concrete, adhesives and rubber compositions, coating compositions and printing inks will regularly comprise larger amounts.

The paint, coating, powder coating, printing ink, coating composition, plastic, adhesive, papermaking stock or rubber composition are employed in accordance with the invention for the production of security documents or security products, such as banknotes, cheques, bank and credit cards, cheque cards, securities, documents such as identity cards, certificates, examination certificates, revenue and postage stamps, identification cards, train and flight tickets, entry tickets, telephone cards, labels, test stamps and packaging materials. This list is only illustrative and should not be regarded as definitive.

In particular on use in security documents and security products which have already been provided with security features in the form of pigment-containing coatings, prints, security strips and the like which are tied to the optical effect of pigments, the addition of the pigment according to the invention as taggant can confirm the authenticity of the pigments used for colouring. The security pigment according to the invention can clearly be distinguished from conventional interference pigments and metal-effect pigments in its wide variety of designs and, merely through its presence, can provide evidence of the authenticity of the said products. At the same time, it can be coded, so that possible forensic security features are intrinsically present.

The invention also relates to a method for the detection of a security pigment, in which a medium comprising the security pigment or a product comprising a medium of this type is exposed to electromagnetic radiation and viewed at a magnification which is sufficiently large to enable, in a first step, the outer shape and size of the security pigment to be recognised and, in a second step, to enable the shape, size, number and/or colour of the particulate material embedded in the matrix to be recognised.

The electromagnetic radiation here is visible light, radiation in the UV wavelength region and/or radiation in the IR wavelength region.

As already described above, the outer shape and size of the security pigment can be determined directly or indirectly. In the case where the refractive index of the matrix and the refractive index of the application medium are significantly different, the outer shape and size of the security pigment can be determined directly.

In the case where the refractive index of the matrix and the refractive index of the application medium are approximately equal, the outer shape and size of the security pigment can be determined indirectly via the number, distribution and/or colour of the particulate material embedded in the matrix, so long as the refractive index of the particulate material is different from the refractive index of the matrix and the refractive index of the application medium.

The shape, size, number and/or colour of the particulate material is determined here on exposure to visible light, on exposure to radiation in the UV wavelength region and/or in the IR wavelength region, where at least two of these regions of electromagnetic radiation act successively on the medium or product.

If the particulate material is, for example, a white, black or coloured pigment or an encapsulated dye, the product comprising the security pigment according to the invention is firstly viewed using a magnification device, such as, for example, a commercially available microscope, under natural or artificial illumination (light microscope) at a magnification which is sufficient to enable the particles having a size in the order of the security pigment according to the invention to be detected. Depending on the refractive index difference of the matrix or, where appropriate, the coating of the security pigment to the application medium, the outer shape of the security pigment will be recognisable or not.

In the case where it is recognisable, with the prerequisite of an irregular pigment shape, it will not be distinguished from the shape of the surrounding pigments employed for colouring. In a second phase, on fresh viewing under visible light, bur at a higher magnification, the individual particles of the particulate material become visible. These are in a conspicuous accumulation and can have colour and size differences amongst one another, which in addition may correspond to a code which only discloses itself to the informed viewer.

The particle accumulations can be distinguished very easily from the surrounding pigments. If they have to be present in the pigmented product according to security instructions, they can easily be identified on establishment of the conditions known to the viewer (only the informed viewer), and evidence of the authenticity of the product (or the printing ink) is provided. If the particulate material corresponds in the manner of its composition to a code, further indications for identification are again necessary for the viewer. These represent a particular security measure (forensic code).

If the particulate material is an IR/UV-active material, the first step of the detection method is exactly as described above.

At higher magnification, the embedded IR/UV-active materials under certain circumstances also become visible in a light microscope, as likewise already described above.

If excitation of the pigment in the IR or UV region is triggered at higher magnification, the respective visible radiation can render individual luminescent particles in the matrix visible. If excitation of this type had already occurred at lower magnification, it would merely have been possible to perceive the radiation generated on IR or UV excitation as such in a certain strength, i.e. as luminescent pigment, but not the individual particles. It goes without saying that the luminescent materials can likewise be varied in size, number and colour, enabling a forensic code to be generated.

It likewise goes without saying that both coloured particles and also UV-active luminescent particles and/or IR-active luminescent particles can be combined with one another in the matrix, both amongst one another and also with one another.

If they are combined amongst one another, the matrix comprises two or more particulate materials which are different from one another and whose colour is in each case only visible on exposure to visible light or to radiation in the UV wavelength region or to radiation in the IR wavelength region.

If, by contrast, they are combined with one another, exposure to radiation in different wavelength regions takes place successively, as already described above.

Besides the respective individual measures which have already been described, the totality of the colours of the different particulate materials which is visible on exposure to visible light or to radiation in the UV wavelength region or to radiation in the IR wavelength region can also give rise to a forensic code.

In addition, the shape, size, number and/or distribution of the particles of the particulate material in the matrix which is visible under the influence of the respective electromagnetic radiation can also be utilised for the formation of a forensic code.

Although already described above, it should once again be pointed out that the medium comprising the security pigment is a paint, a coating, a powder coating, a printing ink, a coating composition, a plastic, an adhesive, a papermaking stock, a building material, a rubber composition or an explosive.

Suitable products which comprise the security pigment-containing medium are virtually all known types of security documents and security products, of which a selection has already been described in greater detail above.

The security pigments according to the invention can advantageously be employed for the identification and authenticity checking of products of a wide variety of types. They can both be employed in a medium which additionally comprises further pigments which serve for colouring, and also added as individual pigments to media which are otherwise unpigmented. Mention may be made here by way of example of paints, coatings and printing inks for the former possibility and colourless coating compositions, adhesives, building materials, papermaking stocks and the like for the second possibility.

The security pigments according to the invention contain intrinsic hidden security features which are attributable to the colour and/or luminescence properties of the particulate material embedded in the matrix. These can be identified in different ways under different conditions, i.e. in a plurality of steps. Depending on the viewer's degree of information, the security pigments according to the invention thus belong to different security classes (identification levels). In addition, the particulate materials embedded in the matrix may, through a specific combination of certain mixtures of particulate materials, also contain a forensic code which does not disclose itself to the uninformed viewer even if he is able to identify the individual particles optically. This requires particular instructions to the viewer. Since many different possible combinations of particulate materials arise without the preparation process for the security pigments having to be considerably modified for this purpose, the security pigment according to the invention can be prepared inexpensively and, depending on the users wish, in high variety. In particular on use of luminescent particles, it should in addition be emphasised that, with a low total concentration of luminescent substances in an application medium, a high identification rate between true and false application media/security products can be achieved, since a high selective concentration of luminescent particles, which can be identified well, is present in the security pigments according to the invention.

The security pigments according to the invention are therefore advantageously employed as taggants, although they would in principle also, owing to their intrinsic colour and/or luminescence properties, be suitable for the sole pigmentation of application media of the type described above.

The security pigments according to the invention accordingly represent a valuable means for product protection with which a very high security level of the respective products can be achieved inexpensively.

The invention will be explained below with reference to examples, which describe the invention in greater detail, but are not intended to restrict it.

### EXAMPLE 1

### SiO₂ Matrix with Embedded UV-Luminescent Particles

A commercially available sodium silicate solution is diluted with demineralised water in the ratio 1:2.5. An additive (1% by weight of Disperse AYT W-22, Poro Additive GmbH) is added to the above dispersion. The mixture is homogenised, and 30% by weight, based on the solids content (SiO₂) of the silicate solution, of ZnS:Cu are subsequently added with stirring. The average particle size of the ZnS:Cu particles here is about 2 μm. The dispersion is mixed vigorously over the period of 1 hour (propeller stirrer, Ultra-Turrax). The dispersion is subsequently applied to a continuously running PET belt by the method described in DE 4134600, dried and detached from the belt, giving flake-form pigments. These are suspended in water and treated with a mineral acid (for example HCl). The resultant pigments are subjected to a grinding process (particle size 2-60 μm) and dried at a temperature of 150° C. for 12 hours.

### EXAMPLE 2

### SiO₂ Matrix with Embedded UV-Luminescent Particles and High-Refractive-Index Coating (TiO₂)

A security pigment according to the invention is prepared as described in Example 1. This is diluted with demineralised water to a solids concentration of 50 g/l and subsequently suspended. The suspension is heated to 75° C., and a solution of 2.25% by weight of SnCl₄ is subsequently added. During the addition, the pH is kept constant using a 32% by weight NaOH solution. After the precipitation of SnO₂, 100 ml of a TiCl₄ solution (400 g of TiCl₄/l of water) are added. The suspension is stirred for a further 15 minutes. The resultant pigments are subsequently separated off, washed with demineralised water and dried at 150° C. for 12 hours.

### EXAMPLE 3

### SiO₂ Matrix with Embedded UV-Luminescent Particles and High-Refractive-Index Coating (Al₂O₃)

A security pigment is prepared as described in Example 1. This is diluted with demineralised water to a solids concentration of 50 g/l, and a solution of 10% by weight of AlCl₃ is subsequently added. During the addition, the pH is kept constant at 7.0 using a 32% by weight NaOH solution. The suspension is stirred for a further 15 minutes. The resultant pigments are subsequently separated off, washed with demineralised water and dried at 150° C. for 12 hours.

### USE EXAMPLE A

### Preparation of a Printing Ink for Solvent-Containing Gravure Printing

15 g of a colour-flop effect pigment (colour change blue-violet), 0.15 g of a security pigment according to Example 1 and 75 g of a nitrocellulose/alcohol blend are stirred with one another using high shear forces. The suspension is subsequently adjusted to print viscosity (DIN 4 cup in accordance with DIN 53211, 14-25 s).

The resultant printing ink is printed on a suitable printing machine (for example Moser-Rototest) by gravure printing with a suitable screen (for example 60 lines/cm, electronically engraved).

The layer thickness (dry) of the printed-on layer is 4-8 μm. The print area obtained exhibits a colour change from blue (steep angle) to violet (flat angle) when viewed in daylight. When viewed under the UV microscope, a large accumulation of luminescent particles is evident at a few points of the print.

Other print applications for the security pigments according to the invention are letterpress printing, flexographic printing, direct offset printing, indirect offset printing, pad printing, intaglio printing or screen printing. The concentration of the security pigments according to the invention in all print applications is 0.05-35% by weight, based on the pigment content of the printing ink.

### USE EXAMPLE B

### Production of a Paper Comprising Security Pigments

A security pigment according to Example 1 is added to the paper pulp in a concentration of 0.5-1% by weight even before moulding and homogeneously distributed by stirring.

The remainder of the papermaking, such as moulding, pressing, drying, etc., proceeds in the usual manner.

Under the light microscope, the security pigments are not recognisable owing to the small difference in refractive indices. Under the UV microscope (excitation at 340-380 nm), the luminescent pigments can be identified well.

### USE EXAMPLE C

### Production of a Building Material Comprising Security Pigments

A security pigment according to Example 1 is added to the aqueous plaster paste in a concentration of 0.5-1% by weight during pasting. The processing and drying of the plaster is subsequently carried out in the usual manner.

Under the light microscope, the security pigments are not recognisable owing to the small difference in refractive indices. Under the UV microscope (excitation at 340-380 nm), the luminescent pigments can be identified well.

1. Security pigment having an intrinsic hidden and/or forensic security feature, consisting of a transparent inorganic matrix and at least one particulate material embedded in the matrix which is different from the matrix and selectively or non-selectively absorbs, reflects and/or emits visible light on exposure to electromagnetic radiation.

2. Security pigment according to claim 1, characterised in that it essentially has a flake shape.

3. Security pigment according to claim 2, characterised in that the flake has an irregular shape on its largest surface in plan view.

4. Security pigment according to claim 1, characterised in that it has a length and width dimension of 1 to 250 μm and a thickness of 0.05 to 12 μm.

5. Security pigment according to claim 1, characterised in that the particulate material is a spherical or three-dimensionally regularly or irregularly shaped material and has a particle size of 0.01 to 12 μm.

6. Security pigment according to claim 1, characterised in that the matrix has a refractive index n₁ and the particulate material has a refractive index n₂, where n₁ is different from n₂ and the difference Δn between n₁ and n₂ is at least 0.2.

7. Security pigment according to claim 1, characterised in that the matrix has a refractive index n₁<1.8 and consists of silicon dioxide, silicon oxide hydrate, aluminium oxide, aluminium oxide hydrate, magnesium oxide or a mixture of two or more of these compounds.

8. Security pigment according to claim 1, characterised in that the matrix has a refractive index n₁≧1.8 and consists of titanium dioxide and/or titanium dioxide hydrate.

9. Security pigment according to claim 1, characterised in that the particulate material is at least one inorganic white, black or coloured pigment, an inorganic UV pigment, an inorganic IR upconverter pigment, an encapsulated organic dye, an encapsulated UV or IR upconverter material or mixtures of two or more thereof.

10. Security pigment according to claim 1, characterised in that the particulate material is titanium dioxide, barium sulfate, zinc oxide, pigment black, iron oxides (haematite, magnetite), chromium oxide, Thénard's Blue (CoAl₂O₄), Rinman's Green (ZnCO₂O₄), cobalt-chromium-aluminate spinel ((Co, Cr)Al₂O₄) or mixtures of two or more thereof.

11. Security pigment according to claim 1, characterised in that the particulate material is a doped metal oxide, doped metal sulfide, metal oxysulfide of the lanthanides or a mixed oxide which is capable of fluorescence or a mixture of two or more thereof, and the particulate material emits visible light on excitation by UV radiation.

12. Security pigment according to claim 1, characterised in that the particulate material is an oxide, halide, chalcogenide, oxyhalide, oxysulfide, fluoroarsenate or fluoroindate of the elements Li, Na, K, Mg, Ge, Ga, Al, Pb, Cd, Ba, Mn, Nb, Ta, Cs, Y, Nd, Gd, Lu, Rb, Sc, Bi, Zr and W which is doped with at least one transition-metal ion, lanthanide ion and/or actinide ion, or a mixture of two or more thereof, and the particulate material emits visible light on excitation by IR radiation.

13. Security pigment according to claim 12, characterised in that the transition-metal ions, lanthanide ions and/or actinide ions are Ti²⁺, Cr³⁺, Ni²⁺, Mo³⁺, Re⁴⁺, Os⁴⁺, Pr³⁺, Nd³⁺, Gd³⁺, Dy³⁺, Ho³⁺, Er³⁺, Tm²⁺, U³⁺ and/or U³⁺.

14. Security pigment according to claim 1, characterised in that the particulate material is a mixture of at least one selectively or non-selectively absorbent material and at least one emitting material.

15. Security pigment according to claim 1, characterised in that the particulate material is present in the matrix in a proportion of 1 to 80% by weight, based on the total weight of the security pigment.

16. Security pigment according to claim 1, characterised in that the particle size of the particulate material in conjunction with the fraction of the particles which can be observed under visible light and/or the colour of the particulate material which can be observed on exposure to visible, UV, and/or IR light represents a forensic code.

17. Security pigment according to claim 1, characterised in that it additionally has a single- or multilayered coating which surrounds it completely.

18. Security pigment according to claim 17, characterised in that the additional coating consists of at least one inorganic dielectric material.

19. Security pigment according to claim 18, characterised in that the additional coating consists of at least one inorganic dielectric material and has, at least on its surface facing away from the matrix, a refractive index n₃ which is different from the refractive index n₁ of the matrix.

20. Security pigment according to claim 18, characterised in that the coating consists of at least one inorganic dielectric material and has, at least on its surface facing away from the matrix, a refractive index n₃ which is different from the refractive index n₂ of the particulate material.

21. Security pigment according to claim 18, characterised in that the coating consists of at least one inorganic dielectric material and has, at least on its surface facing away from the matrix, a refractive index n₃ which is substantially equal to the refractive index n₂ of the particulate material.

22. Security pigment according to claim 18, characterised in that the coating consists of at least one inorganic dielectric material and has, at least on its surface facing away from the matrix, a refractive index n₃ which is different from the refractive index n₄ of a medium surrounding the security pigment.

23. Paints, coatings, powder coatings, printing inks, coating compositions, plastics, adhesives, papermaking stocks, building materials, rubber compositions and explosives comprising a security pigment according to claim 1.

24. A taggant comprising a security pigment according to claim 1.

25. A product according to claim 23, characterised in that the security pigment is employed in a mixture with coloured and/or effect pigments and does not significantly impair, modify or determine the colour impression generated by the latter.

26. A paint, coating, powder coating, printing ink, coating composition, plastic, adhesive, papermaking stock, building materials, rubber compositions or explosives according to claim 23, comprising the security pigment in an amount of 0.0001 to 20% by weight, based on the total weight of the respective material.

27. Security documents or security products, such as banknotes, cheques, bank and credit cards, cheque cards, securities, documents such as identity cards, certificates, examination certificates, revenue and postage stamps, identification cards, train and flight tickets, entry tickets, telephone cards, labels, test stamps and packaging materials comprising a security pigment according to claim 1.

28. Method for the detection of a security pigment according to one or more of claim 1, characterised in that a medium comprising the security pigment or a product comprising a medium of this type is exposed to electromagnetic radiation and viewed at a magnification which is sufficiently large to enable, in a first step, the outer shape and size of the security pigment to be recognised and, in a second step, to enable the shape, size, number and/or colour of the particulate material embedded in the matrix to be recognised.

29. Method according to claim 28, characterised in that the electromagnetic radiation is visible light, radiation in the UV wavelength region and/or radiation in the IR wavelength region.

30. Method according to claim 28, characterised in that the outer shape and size of the security pigment can be determined directly or indirectly.

31. Method according to claim 30, characterised in that the outer shape and size of the security pigment can be determined indirectly via the number, distribution and/or colour of the particulate material embedded in the matrix.

32. Method according to claim 28, characterised in that the shape, size, number and/or colour of the particulate material is determined on exposure to visible light, on exposure to radiation in the UV wavelength region and/or in the IR wavelength region, where at least two of these ranges of electromagnetic radiation act successively on the medium or product.

33. Method according to claim 28, characterised in that the matrix comprises two or more particulate materials which are different from one another and whose colour is in each case only visible on exposure to visible light or to radiation in the UV wavelength region or to radiation in the IR wavelength region.

34. Method according to claim 33, characterised in that the totality of the colours of the different particulate materials which is visible on exposure to visible light or to radiation in the UV wavelength region or to radiation in the IR wavelength region gives rise to a forensic code.

35. Method according to claim 34, characterised in that the shape, size, number and/or distribution of the particles of the particulate material in the matrix which is visible under the influence of the respective electromagnetic radiation additionally gives rise to the forensic code.

36. Method according to claim 28, where the medium comprising the security pigment is a paint, a coating, a powder coating, a printing ink, a coating composition, a plastic, an adhesive, a papermaking stock, a building material, a rubber compositions or an explosive.

37. Method according to claim 28, where the product comprising the medium is a security document or security product.
